(19) United States
(12) Patent Application Publication
(10) Pub. No.: US 2018/0070774 A1
(43) Pub. Date: Mar. 15, 2018

(54) METHOD FOR OPERATING AN ELECTRIC MOTOR-DRIVEN KITCHEN APPLIANCE

(71) Applicant: Vorwerk & Co. lnterholding GmbH, Wuppertal (DE)

(72) Inventors: Andres SAUERWALD, Bottrop (DE); Stefan HILGERS, Essen (DE); Jutta SCHOMACHER, Wuelfrath (DE); Torsten LANG, Solingen (DE); Julius GANNS, Wuppertal (DE)

(73) Assignee: Vorwerk & Co. lnterholding GmbH, Wuppertal (DE)

(21) Appl. No.: 15/554,558

(22) PCT Filed: Mar. 9, 2016
(86) PCT No.: PCT/EP2016/054982

§ 371 Date: Aug. 30, 2017

(30) Foreign Application Priority Data
Mar. 11, 2015 (DE) 10 2015 103 596.0

(51) Int. Cl. A47J 43/046; A47J 31/52

(52) U.S. Cl. CPC A47J 43/046; A47J 31/52

(57) ABSTRACT

The invention relates to a method for operating an electric motor-driven kitchen appliance for preparing a material to be prepared based on a recipe, wherein the material to be prepared is prepared in a vessel of the kitchen appliance via one or more consecutive preparation steps, in particular stirring and/or heating and/or chopping, wherein a current status parameter of the material to be prepared and/or a current operating parameter of the kitchen appliance is determined. According to the invention, for the development of the method, the kitchen appliance transmits information relating to the recipe currently being used for preparation, as well as the determined status parameter and/or operating parameter to a central data storage means of a data communications network, wherein the status parameter and/or the operating parameter is compared to reference parameters for this recipe, and wherein, in the event of a deviation of the status parameter and/or operating parameter from the reference parameters, a correction suggestion is transmitted by the central data storage means and/or by members of the data communications network.

The invention relates to a method for operating an electric motor-driven kitchen appliance for preparing a material to be prepared based on a recipe, wherein the material to be prepared is prepared in a vessel of the kitchen appliance via one or a plurality of consecutive preparation steps, in particular stirring and/or heating and/or chopping, wherein a current status parameter of the material to be prepared and/or a current operating parameter of the kitchen appliance is determined.

All electric motor driven kitchen appliances in terms of the invention are semi-automatically or fully automatically operated kitchen appliances, such as, for example, cooking-mixing devices, with the help of which a user can advantageously carry out a plurality of preparation steps of a recipe. For the most part, these kitchen appliances have a vessel, to which a heating device and a stirrer are assigned, so that a material to be prepared, which is located in the vessel, can be heated and/or stirred. In addition, provision can also be made to chop, to knead or the like, the material to be prepared.

It is furthermore known in the prior art to determine a current status parameter of the material to be prepared or a current operating parameter of the kitchen appliance. Such a status parameter can be a temperature or a weight of the material to be prepared, for example. The kitchen appliance thereby has corresponding sensors, for example a temperature sensor and/or a weighing device. A current operating parameter of the kitchen appliance can be a current temperature of the heating device and/or a current speed of the stirrer, for example. With the help of the determined status parameters and/or operating parameters, a user of the kitchen appliance or also of a control device of the kitchen appliance can make a decision as to whether the current status of the material to be prepared corresponds to the status required for an optimal result. If necessary, a correction can be made in the case of deviations.

Even though this approach has proven itself in the prior art, it is desirable to further improve the support of the user of the kitchen appliance in the preparation of a material to be prepared. It is in particular desired to support each user individually.

To further develop the method for operating an electric motor-driven kitchen appliance, it is thus proposed for the kitchen appliance to transmit information relating to the recipe currently being used for preparation, as well as the determined status parameter and/or operating parameter to a central data storage means of a data communications network, wherein the status parameter and/or the operating parameter is compared to reference parameters for this recipe, and wherein, in the event of a deviation of the status parameter and/or operating parameter from the reference parameters, a correction suggestion is transmitted by the central data storage means and/or by members of the data communications network.

According to the invention, the kitchen appliance is a member of a data communications network. The data communications network has a central data storage means as well as further members. The data communications network can be a so-called “cloud”, for example, in the case of which data, in particular data of the members, are stored in a remote central data storage means. The data storage means is accessed via the data communications network, for example the Internet. On principle, however, the data communications network can also be a private data communications network, for example a company-internal or family-internal Intranet. For the data communication, the members, i.e. also the kitchen appliance, have a data communications module, for example a radio module. According to the invention, the status parameters and/or operating parameters of the current preparation are transmitted to the central data storage means and are compared there to reference parameters with respect to the respective preparation progress of the recipe. The status parameters of the material to be prepared can for example be a temperature, a weight, a density, a color and/or a viscosity. These status parameters are determined with the help of sensors of the kitchen appliance or are calculated from other known status parameters. For example, a temperature of the material to be prepared is determined with the help of a temperature sensor, which is arranged inside the vessel of the kitchen appliance, or a weight of the material to be prepared is determined with the help of a weighing device. Centrally stored reference parameters, which correspond to the respective identical preparation progress of the recipe, are used subsequently for a comparison of these status parameters. Provided that the comparison shows that the current temperature and/or the current weight differs from the reference parameter, a correction proposal is prepared by the central data storage means and/or by members of the data communications network. This correction proposal is suitable to correct the preparation in such a way that the material to be prepared corresponds to the result, which is excepted according to the recipe, or comes at least very close to it. It is possible that the preparation of a correction proposal is only initiated, when the currently determined status parameters exceed a predetermined threshold value. For example, a correction proposal can only be prepared starting at a temperature difference of 5 degrees Celsius or starting at a weight difference of 50 grams. The correction proposal can for example include the information to increase the temperature of the heating device of the kitchen appliance by a certain amount, so that the temperature of the material to be prepared can be raised to the desired value. In the event that the current weight of the material to be prepared exceeds the reference weight, the correction proposal can for example include an extended heating period.

It is proposed for the reference parameters to be stored in the central data storage means of the data communications network. In this respect, the central data storage means has a database comprising a plurality of reference parameters relating to different status parameters and/or operating parameters, which are suggested for the preparation of a recipe. It goes without saying that such status parameters or operating parameters, respectively, are not only stored with regard to a sole recipe, but in fact for a plurality of different recipes. By means of the storage in the central data storage means of the data communications network, a plurality of members of the data communications network can access the reference parameters particularly easily and can make a comparison.

Provision is furthermore made for the reference parameters to be status parameters and/or operating parameters, which are used by a member of the data communications network in response to a preparation. Advantageously, these reference parameters can be transmitted automatically to the central data storage means by a kitchen appliance of the member, in order to also provide said kitchen appliance to other members. The reference parameters can be parameters, which are automatically detected by the sensors of the kitchen appliance, or, in the alternative, parameters, which were stored manually by the member in the central data storage means. In particular, the reference parameters can already include corrections, which the member recognized as being advantageous for the success of the preparation during the course of the preparation of the corresponding recipe. In this respect, the operating parameter “temperature” of a heating device of the kitchen appliance, for example, can be elevated or the operating parameter “heating time” can be extended, in order to obtain the desired preparation result. In this respect, the central data storage means of the data communications network can include a plurality of different reference parameters for the same recipe, which, as intersect as a whole provide for a highly qualified practical support of the user in the preparation of the material to be prepared. It is thereby also possible, for example, for the user of the kitchen appliance to not use all stored reference parameters for comparing to his current status parameters or operating parameters, respectively, but in fact only those from select members. For example, the reason for the selection can be that the corresponding members prefer a similar consistency of the ready prepared material to be prepared. For example, the reference parameters stored by a member can provide for a particularly high speed of the stirrer, in order to obtain a finer consistency of the material to be prepared. Other users, in turn, appreciate a coarser consistency, for example, so that they use a lower speed of the stirrer.

It is proposed for the prepared correction proposal to be transmitted directly from a data communications device of the member. It is possible in this respect that the correction proposal is not prepared by the central server of the data communications network, but in fact by a computer of the member. For this purpose, the member can copy or download the operating parameters and/or status parameters transmitted by a different member and can subject them to his own analysis. The member can subsequently prepare a personal correction proposal and transmit it directly to a certain member, without other members being able to access this correction proposal, for example. As a whole, the user of the kitchen appliance can thus obtain individual, highly-qualified and quick support when preparing a material to be prepared.

The correction proposal can include a large variety of data. This includes, for example, video data, audio data and/or text data. A video file can clearly illustrate a certain preparation step. If the correction proposal consists for example in adding a certain amount of water to the material to be prepared until it has reached a certain consistency or color, the addition and also the expected result can be recorded in the video, in order to visualize the desired result to the user. In the alternative or in addition, it is also possible that the correction proposal does not only include a correction in the actual sense of the word, but additionally also informative video data or audio data with proposals for a wine selection or the like. Music from the region of the recipe or the like can furthermore also be provided.

It is furthermore proposed for the correction proposal to be transmitted to the kitchen appliance and/or an external data communications device. The correction proposal can thus either be transmitted directly to the preparing kitchen appliance or additionally or alternatively to an external data communications device of the user, for example a PC, mobile telephone, tablet or the like.

The correction proposal can thereby be displayed on a display of the kitchen appliance and/or of the external data communications device. It is thus possible for the user of the kitchen appliance to be capable of examining the correction proposal explicitly or also change it. It is furthermore possible for the user to be in direct communication with another member of the data communications network via the data communications device, who provided a personal correction proposal or also experiences relating to the preparation of the corresponding recipe. The direct or also the indirect communication via the central data storage means of the data communications network between different members of the data communications network is thus made possible and is suggested.

Advantageously, the correction proposal can include control data, which are subsequently used by the kitchen appliance for the preparation of the material to be prepared. If the user of the kitchen appliance wants this, the control data can be used directly automatically for the further preparation of the material to be prepared. Time delays are thus not created by an examination of the correction proposal by the user. In fact, the correction is made without help from the user, so that the method execution is particularly simple and uncomplicated. It goes without saying, however, that it is also possible for the user to first examine the correction proposal and to then release it before the control data control the kitchen appliance according to the correction proposal.

Provision can furthermore be made for a chronologically recurring deviation of a status parameter of a material to be prepared in the kitchen appliance and/or a chronologically recurring deviation of an operating parameter of the kitchen appliance to be stored and to be considered in the future preparation of the same and/or of a different recipe in the form of a deviation from an operating parameter of the kitchen appliance according to the recipe. For example, a chronologically recurring deviation of a status parameter of the material to be prepared can be that the material to be prepared always (and in particular unintentionally) has a more liquid consistency than a material to be prepared according to reference parameters. In this case, the evaluation device of the kitchen appliance or also an evaluation device, which is assigned to the central data storage means, recognizes that this status parameter frequently displays a deviation and draws corresponding conclusions. The deviation can for example result from the fact that the user uses food, which has a different consistency than an average food of this type. In particular, this food can be tomatoes, eggs, curds or others, which frequently have a highly varying size or a highly varying liquid content. In these cases, the operating parameters or, if applicable, also the status parameters can be adapted from the outset in such a way that they do justice to the requirements and the used food. For example, the recipe can be changed in such a way that information is display to the user that he is to only use two tomatoes instead of three tomatoes, in order to come particularly close to the desired preparation result. Certain operating parameters of the kitchen appliance can also be adapted to the respective food, for example a longer preparation time can on principle be provided in order to obtain the desired result. For example, provision can also be made for a fundamentally higher speed of the stirrer, if it is known that the user generally uses honey or agave syrup or the like instead of common household sugar.

It is furthermore proposed for information relating to kitchen devices, which are additionally available for a preparation, to be transmitted to the central data storage means. These additionally available kitchen devices are the user's kitchen devices, which are present in the vicinity of the kitchen appliance. These kitchen devices can be additional heating devices, hand blenders, ovens, microwaves or the like, for example. In this sense, a correction proposal can also include the information to prepare a certain ingredient or at least a portion of the material to be prepared in the further kitchen device, in order to obtain a certain preparation result.

Provision can thereby advantageously be made for the kitchen devices to be detected and identified automatically by means of a code scanner or image recognition device. The code scanner or the image recognition device, respectively, can thereby be a camera of a data communications device of the user, such as, for example, a mobile telephone, which takes a picture of the available kitchen devices and transmits it for evaluation to the central data storage means of the data communications network. A search for correction proposals, which provide for a use of one or a plurality of these additional kitchen devices, can then be performed in the data storage means.

The invention will be explained in more detail below by means of an exemplary embodiment.

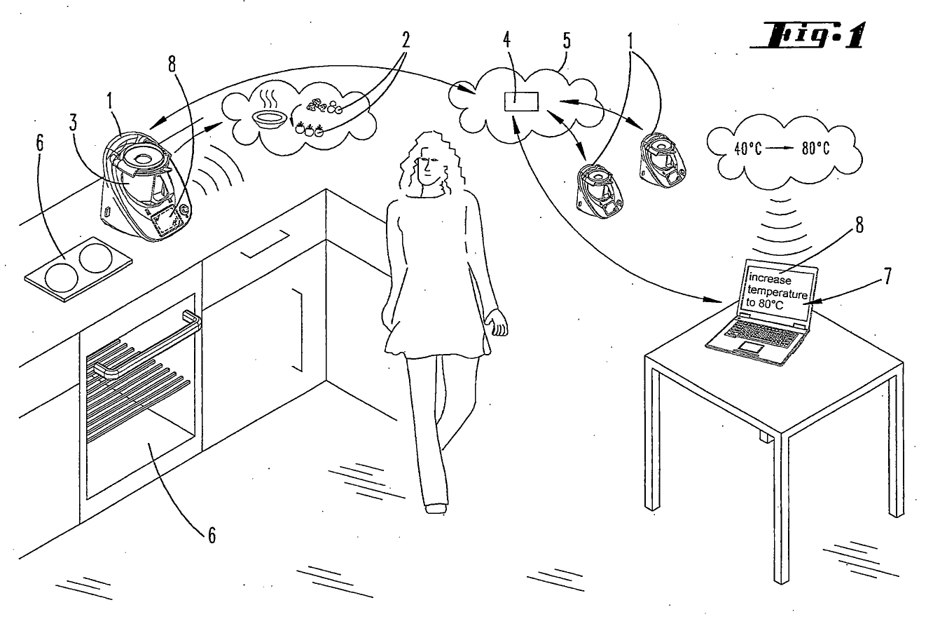

FIG. 1 shows the kitchen of a user comprising a plurality of kitchen devices 6 and a kitchen appliance 1. In the shown exemplary embodiment, the kitchen appliance 1 is arranged on a countertop. The kitchen appliance 1 is embodied as fully automatic cooking-mixing device. The latter has a vessel 3, to which a heating device and a stirrer are assigned. The kitchen appliance 1 furthermore has a display 8, on which information can be displayed to the user and via which the user can transmit corresponding notifications to the kitchen appliance 1. The kitchen furthermore has kitchen devices 6, such as, for example, an oven and an additional heating plate, which, in addition to the kitchen appliance 1, can serve to prepare a material 2 to be prepared.

The kitchen appliance 1 is integrated in a data communications network 5, which other members, in particular further kitchen appliances 1, can access as well. The data communications network 5 has a central data storage means 4, in which recipes as well as reference parameters relating to certain recipes are stored. A data communications device 7, here a laptop of the user, is also connected to the data communications network 5. In a conventional manner, this data communications device 7 has a display 8, on which information can be displayed to the user.

The invention now works in such a way that the user of the kitchen appliance 1 selects a recipe, according to which he wants to prepare a material 2 to be prepared. The user can have taken the recipe from the central data storage means 4 of the data communications network 5 beforehand. The data of the recipe, in particular operating parameters for the kitchen appliance 1, such as temperature settings of the heating device and speed settings for the stirrer, are stored in a local data storage means of the kitchen appliance 1. In the shown exemplary embodiment, the user has selected a recipe, with which a stew can be prepared. The material 2 to be prepared thereby includes tomatoes, potatoes and the like, for example. In a conventional manner, the user fills the material 2 to be prepared into the vessel 3 of the kitchen appliance 1 and then starts the operation of the kitchen appliance 1, which includes a heating of the material 2 to be prepared while simultaneously mixing by means of the mixer. The kitchen appliance 1 thereby uses the operating parameters of the kitchen appliance 1 provided according to the recipe, for example a certain heating temperature of the heating device.

During the preparation of the material 2 to be prepared, sensors assigned to the kitchen appliance 1 measure the current status parameters of the material 2 to be prepared, here for example the temperature of the material 2 to be prepared. The temperature sensor currently measures for example a temperature of the material 2 to be prepared of 40 degrees Celsius. This measured status parameter is transmitted to the central data storage means 4 of the data communications network 5 with information relating to the used recipe and the current preparation progress. Other members of the data communications network 5 also access this central data storage means 4 and store the status parameters measured there in response to a preparation of the same recipe. All of the status parameters determined with reference to the same preparation progress form a database comprising a plurality of reference parameters in the central data storage means 4.

The currently status parameter stored by the user of the kitchen appliance 1 is now compared to the reference parameters. For example, an average of all reference parameters can be used for comparison. On average, the reference parameter, which has led to an optimal preparation result with other members of the data communications network 5, is for example a temperature of 80 degrees Celsius, which differs form the currently measured status parameter (40 degrees Celsius). The reference parameters thus include a correction, which further members of the data communications network have stored in the central data storage means 4, in order to provide other members with information relating to a necessary deviation from the recipe.

In the shown exemplary embodiment, the correction proposal is displayed to the user on the display 8 of his data communications device 7. Concretely, this can for example be the information “attention, raise temperature to 80 degrees Celsius”. The user can furthermore obtain for example personal information from members of the data communications network 5. The option can thereby also be provided to establish a direct communication connection with another member of the data communications network 5 by means of the data communication device 7, in order to obtain even more individual and more direct help.

According to a process, provision can now be made that the user must confirm the change of the operating parameters “temperature of the heating device” to 80 degrees Celsius by means of the data communications device 7. The operating parameter of the kitchen appliance 1 is thereby only taken over for the preparation after confirmation was made by the user. According to an alternative process, it can be provided that the operating parameter, which is to be changed, to be displayed to the user only in an informative manner on the display 8 of the data communications device 7 (or also on the display 8 of the kitchen appliance 1 and to then be taken over fully automatically by the kitchen appliance 1, in order to control the heating device to raise the temperature.

Provision can additionally be made for a correction proposal to only be made when the current status parameter, i.e. the current temperature, has a certain deviation from the reference parameter. For example, a temperature deviation of 5 degrees Celsius cannot already result in a change of the operating parameter of the kitchen appliance 1, i.e. of the current setting of the heating device, while a deviation of degrees Celsius leads to a change of the operating parameter. In the second mentioned case, the correction proposal prepared by the central data storage means 4 of the data communications network 5 can include control data, which are suitable to control the kitchen appliance 1 in such a way that the desired preparation result is obtained.

In response to a repeated preparation of the same recipe, recurring deviations in the consistency of the material 2 to be prepared can appear, for example an end result of the material 2 to be prepared, which is too liquid. It can thus be established by means of a comparison with corresponding reference parameters of the coercion proposal that the user of the kitchen appliance 1 should advantageously only use a smaller amount of a certain food, because it contains an above-average amount of water and thus leads to a liquid material 2 to be prepared. The determination of this recurring deviation can also be available for correction proposal of future preparations of the same recipe. For example, a different amount of food can be proposed to the user from the outset, for example only two tomatoes instead of three.

In addition, the further kitchen devices 9, i.e. the oven or the additional hot plate, can also be integrated in the preparation of the material 2 to be prepared. It is possible, in particular, for correction proposals, which can be recalled from the central data storage means 4 of the data communications network 5 or directly by members of the data communications network 5, to suggest that at least portions of the material 2 to be prepared 2 are kept warm in these kitchen devices 9.

The above-mentioned exemplary embodiment discusses only a single possible process of the method according to the invention for operating the electric motor-driven kitchen appliance 1. It goes without saying that a plurality of further embodiment alternatives is available, which can provide different recipes, status parameters, operating parameters, further kitchen devices 9, etc. In this respect, the illustrated exemplary embodiment is in no way limiting for the invention.

### LIST OF REFERENCE NUMERALS

1 kitchen appliance

2 material to be prepared

3 vessel

4 central data storage means

5 data communications network

6 kitchen device

7 data communications device

8 display

1. A method for operating an electric motor-driven kitchen appliance (1) for preparing a material (2) to be prepared based on a recipe, wherein the material (2) to be prepared is prepared in a vessel (3) of the kitchen appliance (1) via one or a plurality of consecutive preparation steps, in particular stirring and/or heating and/or chopping, wherein a current status parameter of the material (2) to be prepared and/or a current operating parameter of the kitchen appliance (1) is determined, wherein the kitchen appliance (1) transmits information relating to the recipe currently being used for preparation, as well as the determined status parameter and/or operating parameter to a central data storage means (4) of a data communications network (5), wherein the status parameter and/or the operating parameter is compared to reference parameters for this recipe, and wherein, in the event of a deviation of the status parameter and/or operating parameter from the reference parameters, a correction suggestion is transmitted by the central data storage means (4) and/or by members of the data communications network (5), wherein the reference parameters are stored in a central data storage means (4) of the data communications network (5).

2. A method for operating an electric motor-driven kitchen appliance (1) for preparing a material (2) to be prepared based on a recipe, wherein the material (2) to be prepared is prepared in a vessel (3) of the kitchen appliance (1) via one or a plurality of consecutive preparation steps, in particular stirring and/or heating and/or chopping, wherein a current status parameter of the material (2) to be prepared and/or a current operating parameter of the kitchen appliance (1) is determined, wherein the kitchen appliance (1) transmits information relating to the recipe currently being used for preparation, as well as the determined status parameter and/or operating parameter to a central data storage means (4) of a data communications network (5), wherein the status parameter and/or the operating parameter is compared to reference parameters for this recipe, and wherein, in the event of a deviation of the status parameter and/or operating parameter from the reference parameters, a correction suggestion is transmitted by the central data storage means (4) and/or by members of the data communications network (5), wherein the correction proposal is transmitted directly by a data communications device (7) of the member.

3. The method according to claim 1, wherein the reference parameters are status parameters and/or operating parameters used by a member of the data communications network (5) in response to a preparation.

4. The method according to claim 1, wherein the correction proposal is transmitted to the kitchen appliance (1) and/or, an external data communications device (7).

5. The method according to claim 1, wherein the correction proposal is displayed on a display (8) of the kitchen appliance (1) and/or of the external data communications device (7).

6. The method according to claim 1, wherein the correction proposal includes control data, which are subsequently used by the kitchen appliance (1) for the preparation of the material (2) to be prepared.

7. The method according to claim 1, wherein a chronologically recurring deviation of a status parameter of a material (2) to be prepared is prepared in the kitchen appliance (1) and/or a chronologically recurring deviation of an operating parameter of the kitchen appliance (1) is stored and is considered in the future preparation of the same and/or of a different recipe in the form of a deviation from an operating parameter of the kitchen appliance (1) according to the recipe.

8. The method according to claim 1, wherein information relating to the kitchen devices (6), which are additionally available for a preparation, are transmitted to the central data storage means (4).

9. The method according to claim 8, wherein the kitchen devices (6) are detected and identified automatically by means of a code scanner or image recognition device.
